(19) United States
(12) Patent Application Publication
(10) Pub. No.: US 2009/0012863 A1
(43) Pub. Date: Jan. 8, 2009

(54) AUTOMATIC IMAGE ADVERTISEMENT GENERATOR

(76) Inventor: Syta Saephan, Davis, CA (US)

Correspondence Address: MATHEW J. TEMMERMAN, 423 E. STREET, DAVIS, CA, 95616, US

(21) Appl. No.: 12/166,318

(22) Filed: Jul. 1, 2008

Related U.S. Application Data
(60) Provisional application No. 60/958,222, filed on Jul. 2, 2007.

(51) Int. Cl. G06Q 30/00

(52) U.S. Cl. 705/14

(57) ABSTRACT

A method for automatically generating image advertisements to supplement text advertisements within an advertisement group, the method comprising a means for determining the most relevant image on a destination URL linked to by an advertisement. Preferably, the method comprises obtaining at least two advertisement attributes selected from the group consisting of keywords for an advertisement, titles of text ads for an advertisement, subtitles of text ads for an advertisement, and destination URLs associated with an advertisement, then obtaining at least two image attributes selected from the group consisting of image file name, image file location, image “alt” attributes, and URL linked to through image, then through a comparison of said at least two ad group attributes to said at least two image attributes relevance of an image is determined, where a number of potential images may be used as one component to create the advertisement, the most relevant image is used in the creation of the advertisement for display to a user in the form of an advertisement.

### RELATED APPLICATIONS

This application is related to previously filed U.S. provisional patent application Ser. No. 60/958,222, filed Jul. 2, 2007, entitled “Automatic image advertisement generator”, which is incorporated by reference herein as if set out in full.

### BACKGROUND

1. Field of the Invention

The present invention relates to web-based advertising systems, and in particular to a system for automatically generating image based advertisements.

2. Background of the Invention

The Internet has become one of the most convenient and effective advertising mediums through which information providers offer information, goods, and services. Through graphical user interfaces (“browsers”) users may easily access network servers and computers connected to the Internet. Each server connected to the Internet may contain documents formatted as web pages viewable on a website through the users's browsers. Often websites will contain selectable references (“links”) to other electronic documents. In addition to links to other websites, websites also commonly contain text, graphics, images, sound and/or video. For businesses looking to capitalize on the Internet, a common choiceis to make information, goods, or services available through a website as well. Because of the low cost associated with creating a website and the high number of such websites available for users to select from, making one website stand out from the others is a pervasive problem for website operators.

For most web-related business models, revenue is closely related to the amount of traffic to the business's website. Increasing site traffic is thus a nearly universal goal for businesses such as content providers, web-based stores and service providers. To that end, much innovation has come about over the past several years. One such means for garnering traffic is through paid advertising (“ads”) on the web. Ads have become a nearly ubiquitous part of the Internet. When clicked on by a user, the user's browser is redirected to a webpage specified by the purchaser of the ad. The purchaser of the ad is only charged when a user clicks on its search ad, hence the “pay-per-click” search business model, wherein the ad purchaser is charged for one “click” or one count of traffic. Companies such as Google, Inc. and Yahoo, Inc. have made a business out of this and currently offer pay-per-click ad campaigns for companies looking to increase web traffic to their online store or service. For purposes of this patent application the term advertiser shall be reserved for the entity responsible for presenting the ad to the user. Purchaser of the ad shall refer to the entity that purchases ads from the advertiser.

Because there are myriad companies willing to sell advertising, it can be a time consuming process for a business to prepare advertisements to meet the various requirements of the different companies. To prepare ads for those advertisement companies that offer both text ads and images ads, the time investment is even higher.

Two types of ads that are available through the various advertisement companies can be generally categorized into text ads and images ads. Each type of ad can be further subcategorized. “Search ads” is one such subcategory, and is exclusive to text ads. Search ads are placed on a search results page and are based on a user's search query. Search ads are shown in prominent locations relative to natural search results. In an exemplary case describing the function of search ads, a store with hundreds of products may have a need to increase traffic to the store website by investing in both text ads and image ads with an advertisement company. Preparing the text ads is generally an easy process, even though each product may have multiple text ad variations. When creating the text ads, generally all variations of an ad are placed into one ad group. For example, an ad group might contain all of the ads for one specific product. Each product would thus have its own ad group. Specific keywords and destination URLs to which each ad in the ad group will be linked are associated with the ad group. In this exemplary case, when a potential customer searches on a web search engine using the keyword(s) associated with the ad group, one of the text ads in the ad group will be served to the potential customer along with the natural search results of the user's query. The potential customer may then click on the link taking the potential customer to the destination URL. These ads are referred to as “search ads” because they are served only when a user searches for the specific keywords associated with the ad. In practice, for any individual search query or keywords, there may be multiple ad purchasers bidding for ad placement, and the search results page may show multiple search ads from such purchasers.

If a text ad is not a search ad, it is generally a “content ad”, the second major subcategory of advertisements. Unlike search ads, content ads are not exclusive to text ads. In a second exemplary case, the advertiser uses content ads, which push advertisements to third party websites that are related to the page content on the third party website. “Google Adsense” is a widely used advertising service provided by Google, Inc. that allows website owners to enroll their website to display content ads provided by Google (the advertiser). Continuing with this exemplary case, the advertisements are purchased by the web store, service or content provider from the advertiser, who publishes the content ads. The content ads are sent by the advertiser to a third party website not necessarily owned by the advertiser. Beforehand, the third party web site to which the ad is sent generally enters into an agreement with the advertiser such that the third party web site allocates space on the website that will be filled with content at the discretion of the advertiser, and to the benefit of the web store, service, or content provider in need of increased traffic. In content ads, the content of the third party page is scanned by the advertiser, which will then serve advertisements to the allocated space that are relevant to the content on the third party page. For instance, a third party page about new car buying tips might be given ad to display for a local car dealership. The hope is that the potential customer already has an interest in the content on the third party page, and would be more likely to thus click on an advertisement associated with that content.

Whereas the search ads must be in text format, content ads can be in either text format or image format. There are other differences as well. For instance, in many search engines, the search ads are always placed in the same location on the search results page. Under Google's system, many potential customers are accustomed to looking for relevant search ads in the top and right side of a Google search results page, and in a consistent size and font. Unlike search ads, content ads do not generally have such uniformity in terms of placement location or size/shape. Because the third party website on which the content ads are placed is not necessarily owned by the advertiser, the third party website may display the content ads essentially anywhere the third party website designer chooses. The ads may even change location from day to day as changes are implemented to the website. Under Google's system, however, the third party websites to which the content ads will be placed must allocate a space on the website in the shape of one of the eight size and shape combinations shown in FIG. 1. Where the ad box goes is left up to the third party website. Other advertisers have similar systems that require content ads to be a specific size. For instance, Google can put a single text ad in large font in a large space, or put multiple text ads in small font in that same space, and in text-formatted content ads, can easily adjust the text font size to fit the available space.

One problem facing the purchasers of content ads from an advertiser is that most potential customers visiting the third party website on which the content ads are placed are generally more interested in the content of the third party website than they are in the advertisement being offered to them. Thus, it is in the interests of the purchaser of an advertisement to create an advertisement that will stand out to their potential customer, and thus increase the likelihood that the potential customer will click on the ad.

Like newspapers, magazines and other advertising mediums, factors such as location and size of an ad on the web affect the likelihood the ad will attract the attention of its target audience. For instance, advertisements appearing at the bottom of a webpage are less likely to be noticed by and clicked on by potential customers. Generally, web pages require the active decision of the user to scroll down in order to view the bottom of the page. Ultimately, ads placed at the bottom of a page are often overlooked by potential customers, and thus generate little business. This is particularly true with text advertisements, while image advertisements tend to perform slightly better. In fact, an image ad placed in the exact same location as a text-formatted ad for the same product will generally garner increased user attention and higher click-through rates by potential customers. Since content ad click-through rates are usually lower than comparative search ads, and text formatted content ads are comparatively lower still, it becomes very important to have any advantage in content ads. To this end, relevance in image content ads becomes a very important factor, and there is thus a need for purchasers of ads to generate highly relevant image ads for the ad campaign.

Despite the increased success of image-based content ads over their text-based content ad counterpart, use of image-based content ads in practice is surprisingly not commonplace. This is due to the large investment of time required to prepare an image ad campaign vs. a text ad campaign. Most web businesses simply do not have such time to spend preparing relevant image ads. While the time to create a text-formatted ad can easily be fewer than 30 seconds, to produce an image ad, at the very least one would need to upload an image and some related text to accompany it. Further, the image advertisements must generally meet the size requirements of the advertiser, an example of which is depicted in FIG. 1. Formatting the images to fit the ratio of pixel height and pixel width demanded by the available sizes (FIG. 1) requires additional work. Finally, the look of a product (and thus an image to advertise it) is more likely to change over time than is the name of a product. Thus, a company that wishes to advertise hundreds of products, particularly that change frequently, would not likely have the time or resources to manually create all of the image ads needed for a successful ad campaign. There is thus a need for a tool that can take existing text-formatted ads and automatically generate relevant image-formatted ads.

It is thus an object of the invention to provide a tool that can take existing text-formatted ads and automatically generate relevant image-formatted ads. In a preferred embodiment of the invention, the image-formatted ads simply become additional ad variations to

supplement the text ads within the ad group. After generation of the image-formatted ads, the ad group contains both text-formatted ads and image-formatted ads. Finally, an advertiser may rotate amongst the ad variations and give more ad impressions to the better performing ads.

3. Description of Related Art

U.S. Pat. No. 5,937,392 to Alberts describes an “Internet advertising system having a database, a controller, and an ad server operating as part of a web server. The database has advertising campaign information, including identification information and frequency information for how often the ad is to be served. The ad server uses the campaign information from the database to control the relative ratios of serving ads, the distribution of ads throughout the day, and any triggering mechanisms for controlling what ads are served.

U.S. Pat. No, 6,128,655 to Fields et al. identifies the general concept of reformatting the content of one web page for placement on another, but merely extracts and recasts the desired content. No decision is made as to the relevancy of the information recast.

U.S. Pat. No. 6,693,652 to Barrus et al. is titled a “System and Method for Automatic Generation of Visual Representations and Links in a Hierarchical Messaging System” and describes a system in which an image, including a thumbnail image of the object's contents and a link to the original content, is created in response to simple user inputs or commands.

U.S. Pat. No. 6,981,224 to Gardner et al. is entitled “System and Method for Conditionally Associating a Plurality of Enabled Images with a predetermined Image” and U.S. Pat. No. 7,039,599 to Merriman et al. is entitled “Method and Apparatus for Automatic Placement of Advertising,” but again, both do not fully answer the unresolved need in the industry for providing a tool that can take existing text-formatted ads and automatically generate relevant image-formatted ads.

There is thus very little that has been done to remedy the amount of time it takes to prepare an image ad campaign vs. the time it takes to prepare a text ad campaign.

### SUMMARY OF THE INVENTION

A system and method is provided for automatically generating image advertisements for both search ads and content ads. In a preferred embodiment, the automatically generated image advertisements supplement and are generated from text advertisements as part of an advertisement group “ad group” associated with a product or service to be advertised online. Images relating to the content of the website being advertised are automatically generated for use in an advertiser's ad. Using keywords associated with text ads for the information, product or service, along with using information already available on the website to be advertised, ads may be displayed to end users of various Internet search engines. The image ads can be served in lieu of a text ad where permitted by the search engine or third party website.

### BRIEF DESCRIPTION OF THE DRAWINGS

The foregoing aspects and many of the attendant advantages of the invention will become more readily appreciated as the same becomes better understood by reference to the following detailed description, when taken in conjunction with the accompanying drawings, wherein:

FIG. 1 depicts a common example of an advertiser's permitted advertisement sizes; and

FIG. 2 depicts a summary flowchart of the applicant's system and method.

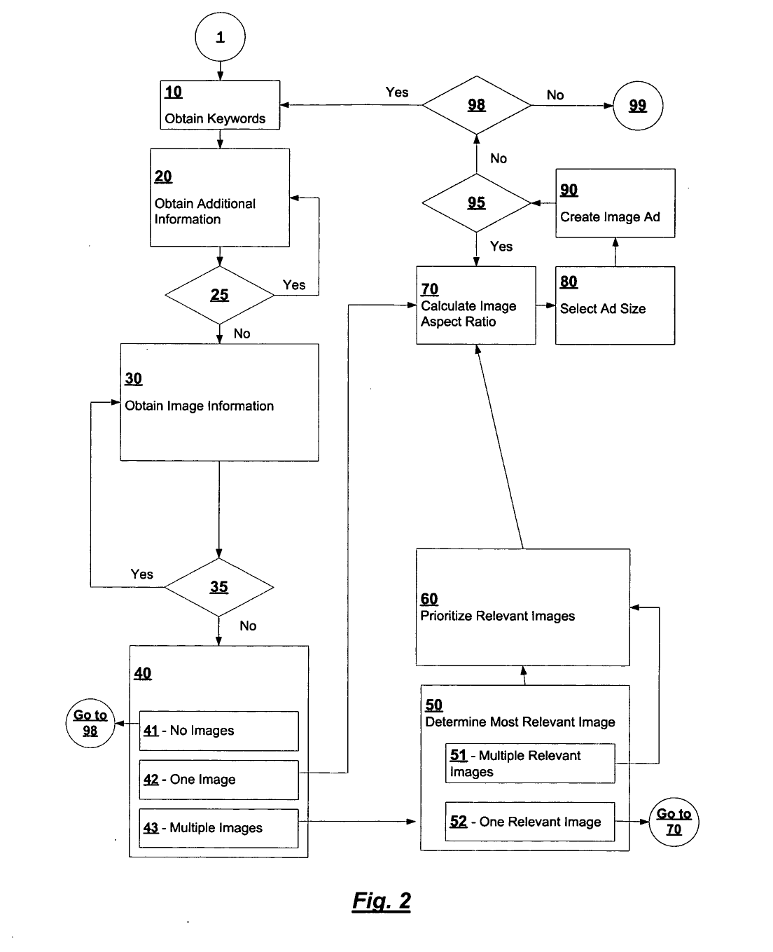

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

The applicant discloses a system related to advertisements (“ads”), and specifically a system for automatically creating image advertisements with minimal to no input from the creator of the ad beyond the initial setup. In a preferred exemplary embodiment of the invention the image ads supplement text ads within an ad group as ad variations, and are displayed by advertisers to potential customers on the Internet. In an alternative embodiment of the invention the system is used to create single image advertisements based on single text advertisements that are not part of an ad group. For each text-formatted ad, there may be at least one related image-formatted ad automatically created without additional user input or intervention.

As described above, content ads are supplied by an advertiser to a third party website, based on the content of the website, and search ads are run by the advertiser directly, on the advertiser's search engine website. Generally an ad purchaser pays the advertiser to place the ad on either the third party website, the advertiser's search results page, or both. For purposes of this patent application, an ad can refer to text ads or image ads, as well as video, sound or other media. Generally ads contain within them a link to a “destination URL”, which refers to the uniform resource locator (the website address) to which a potential customer will be taken when the potential customer clicks on the ad with a computer pointing device, but an ad is also useful even if it is never clicked, in that it may raise name recognition for the purchaser of the ad. The destination URL is generally a website controlled by the purchaser of the ad, and generally has further information regarding the content of the ad.

The applicant's system determines which images will be used in connection with the ad, and it does so upon analysis of a number of factors, including but not being limited to (a) keywords within the ad group, (b), titles of text ads within the ad group, (c) subtitles of text ads within the ad group, (d) destination URL for ads within the ad group, and (e) images used on the destination URL.

Starting at reference number 1, the applicant's system first requires keywords for use with the ad group, as shown at box 10. The purchaser of the advertisement (generally, the web store, web service or content provider) has generally already provided these keywords as part of any text-based ad campaign. As described above, these keywords traditionally tie the text ads to either the search performed by the potential customer, or the content of the third party webpage visited by the potential customer. At box 20 the system obtains additional information regarding the text ads, such as text ads titles, text ad subtitles, and a destination URL for ads within the ad group. At box 25 a check is made whether there are additional ad variations within the ad group. If there are, additional information (box 20) is obtained for each variation of ads within group. Once box 25 is answered in the negative, the system obtains image information at box 30.

At box 30, the applicant's system obtains images from the destination URL associated with the ad group. For each image obtained, the file name of the image on the destination URL is also obtained (e.g. black-car.jpg), as well as the image file location path (e.g. /web/images/car/black-car.jpg), the image's HTML “alt” attributes, the destination URL to which the image links (if the image in question is itself also a link), the image file size (e.g. 15 KB), the pixel dimensions of the image (e.g. 100×200 pixels), its absolute location placement (e.g. near the top, bottom, etc.), its relative location placement (e.g. third image in a group of five images), and its proximity to keywords on the webpage. The “alt” attributes of an image are keywords or very short descriptive words the ad purchaser may have associated with a particular image within the HTML tags that would be displayed either when the user hovers a cursor over the image or when the user's browser requires a placeholder in the event the image cannot be displayed.

If there are multiple images on the destination URL for the ad group, as many of these attributes as possible will be obtained for each image, with the goal in mind of selecting the most relevant image found on the destination URL for use as the image in the advertisement for said destination URL. There are generally many images on any given destination URL, and in a preferred embodiment, these are the only images used by the system. This becomes important for large multiuser domains such as Amazon.com and EBay.com. In these instances, only the specific web page owned by the ad purchaser would likely contain images relevant for the ad, and thus in the preferred embodiment only these images are used, and no others. Thus, at box 35 a check is made whether there are additional images on the destination URL for which the above attributes were not obtained. If there are, box 30 repeats until there are no more images for which attributes must be obtained.

Once box 35 is answered with a “no”, the applicant's system moves to box 40, wherein it makes the first (and in some cases only) step as to which image will be used to create the image ad, if in fact any image is used at all. For instance, if the advertisement destination URL contains no images (box 41), then no image is displayed and the system moves immediately to reference number 98. Likewise, if the destination URL has only one image (box 42), then that image is used to create the image advertisement and the system jumps immediately to box 70. Generally, however, the destination URL will have multiple images (box 43), in which case the system determines the most relevant image to use.

In cases where the destination URL has multiple images that may be used, the acceptable images are ranked in terms of relevance. See box 50. Through an analysis of relationship between the text ad and the images on the destination URL, the most relevant image to associate with the ad is determined. Specifically, factors associated with the text ad (keywords, ad titles, ad subtitles) and factors associated with the images (file name, file location, alt attributes, destination URL if image is a hyperlink, file size, image dimensions, absolute page location, relative page location, and proximity to keywords on destination URL) are compared. Often, some of the respective factors may be unavailable, in which case the most relevant image is still determined based on those factors that are.

In one exemplary system, the highest relevance level is given where an image's file name (or part thereof) matches an ad group keyword. For instance, in a text ad having the keyword “new car,” an image on a destination URL for that text ad having a file name new_car_blackjpg is given the highest relevance level. If no image satisfies this highest level of relevance, then in this exemplary case the system compares the image file name against the ad title. If no image satisfies the previous level of relevance, then in this exemplary case the system compares the image file name against the ad subtitle. If no image satisfies the previous level of relevance, the system may compare the destination URL linked to by the image (if in fact the image is also a link) to the ad title. Again if no image satisfies the above level of relevance, the “alt” attributes of the image are matched first against the ad group keyword, and if no match is found then the “alt” attributes are subsequently matched against the ad title, the ad subtitle and finally the URL linked to by the image if in fact the image is also a link. If there is still not a match, the image's file location is matched against the ad group keywords, then as above, against the ad title, the ad subtitle and potentially the URL linked to by the image in a least relevant case. In this exemplary system, if there is still no match between the image file location the ad's subtitle, then no further comparisons are made and no image is used. In alternative embodiments, the hierarchy of relevance described in this paragraph may be reorganized.

In another exemplary system, a weighted value may be used, wherein for instance the exact keyword to image file name match described above is given a weight of 10, while a match to a synonym (i.e. matching keyword “new car” to “automobiles” is given a weight of 5. Other degrees of matching are given other weighted scores, i.e. matching to a plural or modified form of the singular keyword results in a weighted score of 8. A sum total of all of the weighted scores can be used to rank the destination URL images in terms of relevance. The image with the highest weighted score would be considered the most relevant, and would be used in connection with the advertisement. An advantage to this exemplary system is that over time, minor corrections in weighting could be made to increase the accuracy of the system. In any event, the comparison between ad attributes and image attributes is made. A number of relevance determining systems are currently employed in the art, and in fact many are used in web search engines themselves. Any of these commonly understood algorithms for comparing words for relevance may be employed in the applicant's system without departing from the spirit of the invention. The end result, however, is always a determination of the most relevant image on the destination URL based on a comparison between the words associated with the image and the words associated with the text on which it is to be used.

If after the above determination of relevance, there is only one image with the highest relevance, than this one image is used. See box 52. If, however, two images are determined to be equally relevant, then the two images will be ranked in order of priority. See box 51 leading to box 60.

A first exemplary means to prioritize images of equal relevance is to simply put a higher priority on images that have a larger pixel area. In this simple embodiment, the largest image is used. If two images are of equal pixel area, the second means of determining priority is used, wherein the image closest to the top of the destination URL webpage is used. Again, if two images are of equal size and of equal distance to the top of the web page, then a third means of determining priority is used, wherein images that are closer in proximity to keywords on the webpage that match keywords in the ad group are used. In the event all three means fail to place one image in higher priority than any other, the image on the left of the two images equidistant to the top of the page is used.

In an alternative embodiment, a weighted score may be given to each of the above factors, wherein for instance, the largest image may be given a score of 10, and an image one half the size of the largest is given a score of 5 and an image one tenth the size or smaller is given a score of 1. Similarly, the image closest to the top of the destination URL webpage may be given a score of 10, while an image halfway down the page is given a 5 and an image at the bottom of the page is given a score of 1. Finally, the image closest to the keyword is given a score of 10, while the next closest may be given a score of 9, and so on. By adding up the three scores, priority may be determined. If in the event two equally relevant images are also determined to be of equal priority, then the image in the upper top left may be used, similar to as occurs in the first described embodiment for determining priority. As in the embodiment of the invention using weighted scores to determine relevance, the values of the weighted scores to determine priority can be adjusted over time as more empirical performance data becomes available. If necessary, specific multipliers for the weights may be employed in either embodiment.

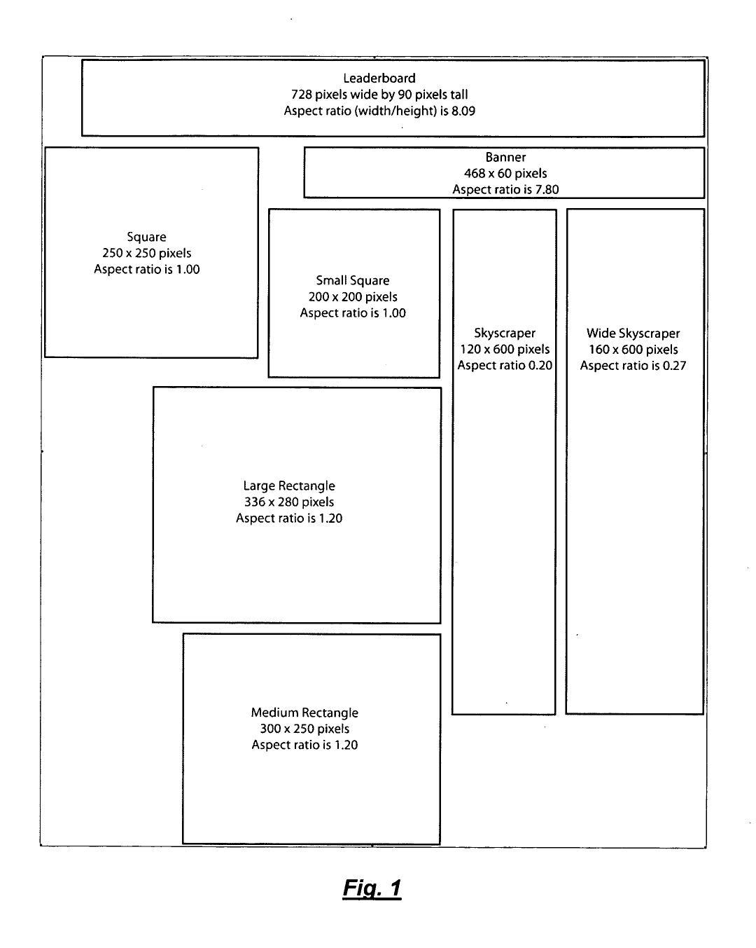

Once the image to be used is determined, the shape and placement of the ad is calculated, as shown in box 70. As an exemplary case, the eight ad shapes shown in FIG. 1 will be used as a target size for the image being created. In practice, any target size may be used. First, the ratio of the width to height of the selected image is determined. This is compared to the available ad sizes (in the example referring to FIG. 1 there are eight ratios) and the ratio of the available shape that most closely matches the ratio of the image is chosen, as shown in box 80. Finally, and at box 90, additional modifications may be made to the image before the image's use in the advertisement. Modifications may include for instance the resizing of the image to fit the dimensions of the available ad space, or changing the color scheme on the image from color to black and white. Other enhancements and color changes as are known in the art may be made. This combined image/text file ideally has a ratio that is close to the ratio of the ad space available. For example, if image1.jpg and its text are 400 pixels wide by 300 pixels tall, then image1.jgp's suspect ratio is 1.33, and it may be used to create a large rectangle ad with a ratio of 1.20 (the closest fitting match of the available sizes shown on FIG. 1.).

In another alternative embodiment of the invention, various ads may be created from one text ad by choosing more than the most relevant images from the destination URL. Box 95 represents the option of creating additional images (yes) or creating no additional images (no) for the ad group. For instance, the five most relevant images may be used from the destination URL, and through data collection and performance analysis of the ads, the advertiser can selectively use images having the highest click-through ratios more frequently than those images that provided lower click-through ratios. The performance data may also be sent to the purchaser of the ad to provide feedback for the purchaser as to the success of the ad purchaser's ad campaign. Thus, a yes answer at box 95 returns the system to box 70 wherein an additional image is prepared for use as an image advertisement. A no answer at box 95 moves the system to box 98.

Box 98 is simple query as to whether the system should repeat the process from reference number 10 for other ad groups. If so, the system returns to box 10, but if not the process is complete at reference number 99.

In a preferred embodiment, the applicant's process will be enabled through software that affects the activity on the advertiser's server. For instance, through only slight variations in the software currently employed by many advertisers, automatic generation of image ads based on text ads is possible. Preferably, nothing further is required of the ad purchasers than what is already provided for with regard to text ads. All the information needed for complete automation is already either a part of a typical ad group or can be retrieved at the destination URL. Because no additional information is needed, the applicant's system may be easily integrated into existing systems in place with advertisers and well known by purchasers of the ads. Further, ad purchasers see a benefit because they will have the ability to run image advertisements without the large time investments normally associated with such an ad campaign. Finally, because advertisers charge their clients per click, advertisers may benefit as more potential customers click on the ads.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A method for automatically generating an image advertisement for use over a network, the method comprising:
a. storing a destination URL for an advertisement;
b. storing as an advertisement attribute at least one of advertisement keywords, text advertisement title, or text advertisement subtitle;
c. storing as an image attribute from an image used on a webpage linked by said destination URL at least one of image file name, image file location, image “alt” attribute, or URL linked to through image;
d. comparing said at least one image attribute to either said destination URL or said at least one advertisement attribute to determine relevance of said image used on a webpage linked by said destination URL; and
e. selecting an image for use in said image advertisement, said selection based on relevance of said image for use in said image advertisement.

2. The method according to claim 1 wherein said comparing step is performed at least twice and wherein in said selecting step the most relevant image is selected.

3. The method according to claim 2 wherein said comparing step is performed at least five times.

4. The method according to claim 1 wherein at least two advertisement attributes are stored and wherein said comparing step compares said image attributes to at least two stored advertisement attributes.

5. The method according to claim 4 wherein said comparing step is performed at least twice and wherein in said selecting step the most relevant image is selected.

6. The method according to claim 5 wherein said comparing step is performed at least five times.

7. The method according to claim 4 wherein at least two image attributes are stored and wherein said comparing step compares at least two image attributes to at least two advertisement attributes.

8. The method according to claim 7 wherein said comparing step is performed at least twice and wherein in said selecting step the most relevant image is selected.

9. The method according to claim 8 wherein said comparing step is performed at least five times.

10. The method according to claim 1 wherein at least two image attributes are stored and wherein said comparing step compares at least two image attributes to either said destination URL or said at least one advertisement attribute; and
a. determining priority of an image based on said at least two additional image attributes.

11. The method according to claim 10 wherein said comparing step is performed at least twice and wherein in said selecting step the most relevant image is selected.

12. The method according to claim 11 wherein said comparing step is performed at least five times.

13. An advertising system comprising:
a. a web server for providing information to a user over a network in response to being accessed by said user, the web server including an advertising server for providing advertising information to said users;
b. a means for obtaining from an ad purchaser a destination URL associated with an advertisement;
c. a second means for obtaining from an ad purchaser as an advertisement attribute one of a keyword associated with said advertisement, title of said advertisement, and subtitle of said advertisement;
d. a means for obtaining for each of a plurality of images from said destination URL as an image attribute one of image file name, image file location, image “alt” attributes, and URL linked to through image;
e. a means for comparing each of said plurality of image attributes against either said destination URL or said advertisement attribute to determine relevance ranking of each of said plurality of images; and
f. a means for selecting the image having the highest relevance ranking for use in an image advertisement.

14. The advertising system according to claim 13 further comprising a means for determining priority of each of said plurality of images.

15. An advertising system for disseminating advertisements over a user-accessed network, the system comprising:
a. an advertising database with advertising data, said data including at least two of keywords for an ad group, titles of text ads for an ad group, subtitles of text ads for an ad group, and destination URLs associated with an ad group;
b. a means for obtaining from an image displayed on a webpage linked to by said destination URL at least two image attributes selected from the group consisting of image file name, image file location, image “alt” attributes, and URL linked to through image;
c. a means for comparing said at least two ad group attributes to said at least two image attributes to determine relevance of an image;
d. a means for selecting an image based on relevance of the image; and
e. a means for providing said image to users in the form of an advertisement and in response to requests from said users.
